(19) United States
(12) Patent Application Publication
(10) Pub. No.: US 2006/0066884 A1
(43) Pub. Date: Mar. 30, 2006

(54) Printing control apparatus and method of controlling the printing thereof

(75) Inventor: Takeaki Kato, Mishima-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki kaisha, Chiyoda-ku (JP)

(21) Appl. No.: 10/949,150

(22) Filed: Sep. 24, 2004

(51) Int. Cl. G06F 3/12

(52) U.S. Cl. 358/1.13; 358/1.9

(57) ABSTRACT

The present invention stores color setting and monochromatic setting including the number of print copies respectively in different Devmode structures, at the time of color print and monochromatic print, refers to the respective storage locations, performs printing, thereby can obtain simultaneously both color print and monochromatic print.

### BACKGROUND OF THE INVENTION

1. Field of the Invention

The present invention relates to a printing control apparatus and a control method therefor for controlling a plurality of print modes of color print and monochromatic print.

2. Description of the Related Art

For print data including color print and monochromatic print, print data in one print mode is printed and during the period, a print document in the other print mode is stored in a storage means. And, a printing control apparatus for printing print data in the same job, then switching the print mode to the other print mode, next, printing print data in the other print mode, thereby reducing the switching count of the print mode is disclosed in Japanese Patent Application 2001-88355.

During printing, a printer driver for controlling a printing control apparatus connected to a computer receives data including color print mode setting from an application, prepares a print job, transfers the job to an operating system of the computer, and finishes the operation thereof.

When performing one driver operation or preparing one job, only either of color setting and monochromatic setting is used for printing. Namely, a user, when performing both color print and monochromatic print for an article to be printed, needs to perform print two times.

Therefore, an easily operable printing control apparatus is desired.

### BRIEF SUMMARY OF THE INVENTION

According to embodiments of the present invention, an object of the present invention is to provide a printing control apparatus and a control method therefor for setting color print and monochromatic print by one operation and obtaining respectively the number of copies designated by a user.

The present invention may provide a printing control apparatus, comprising:
(1) a print setting means capable of setting simultaneously print modes of color print and monochromatic print for the same data to be printed,
(2) a generation means for generating a plurality of print jobs of color print and monochromatic print set by the print setting means from the data to be printed, and
(3) an execution control means for executing printing by the plurality of print jobs generated by the generation means.

The present invention may provide a print control method, comprising:
(1) a print setting step capable of setting simultaneously print modes of color print and monochromatic print for the same data to be printed,
(2) a generation step of generating a plurality of print jobs of color print and monochromatic print set by the print setting step from the data to be printed, and
(3) an execution control step of executing printing by the plurality of print jobs generated by the generation step.

### BRIEF DESCRIPTION OF THE DRAWINGS

Further objects and advantages of the invention can be more fully understood from the following detailed description taken in conjunction with the accompanying drawings, in which:

FIG. 1 is a block diagram showing the constitution of the printing control apparatus of the embodiment of the present invention and a flow chart showing the control process for the driver of the printing control apparatus of the first embodiment of the present invention,

FIG. 2 is a block diagram showing the function constitution of the print process of a host computer,

FIG. 3 is a flow chart for explaining the operation of the spool file manager,

FIG. 4A is a GDI diagram showing the setting of the number of color and monochromatic print copies in this embodiment,

FIG. 4B is a GDI diagram showing the setting of the number of color and monochromatic print copies in this embodiment,

FIG. 5A is a GDI diagram showing the detailed print setting in this embodiment, and

FIG. 5B is a GDI diagram showing the detailed print setting in this embodiment.

### DETAILED DESCRIPTION OF THE INVENTION

An embodiment of the present invention will be explained below with reference to the accompanying drawings.

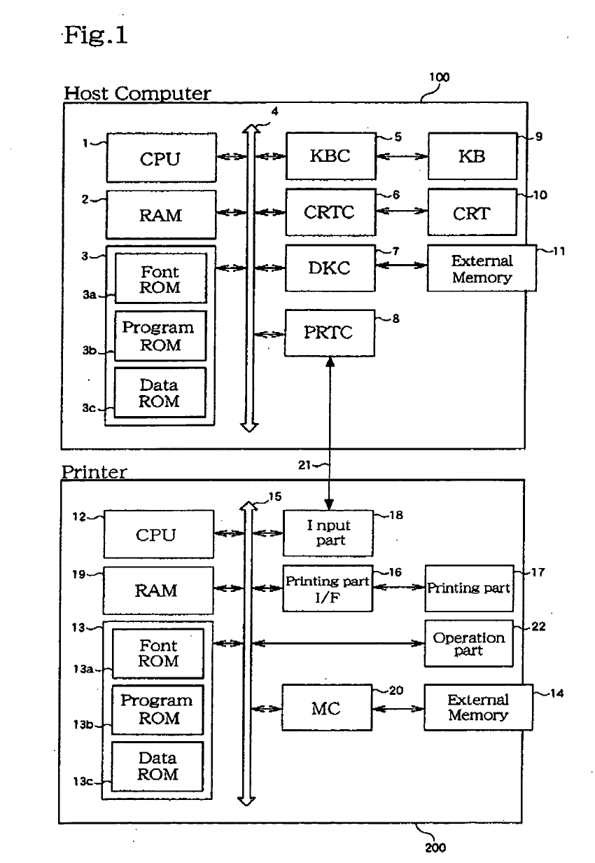

FIG. 1 is a block diagram for explaining the constitution of the printing control apparatus in this embodiment. Further, if the function of the present invention is executed, needless to say, to any single device, any system composed of a plurality of devices, or any system connected via a network and processed, the present invention can be applied.

In FIG. 1, a host computer 100 is composed of, for example, a CPU 1, a RAM 2, a ROM 3, a system bus 4, a KBC 5, a CRTC 6, a DKC 7, a PRTC 8, a KB 9, and a CRT display 10. The host computer 1 may use a general purpose computer. The CPU 1 realizes various processes in the host computer 100. For example, the CPU 1, on the basis of a document processing program stored in a program ROM 3b of the ROM 3 or an external memory 11, executes a document process including coexistently figures, images, characters, and tables (table calculation included) Furthermore, the CPU 1 controls overall the devices connected to the system bus 4.

In the program ROM 3b of the ROM 3 or the external memory 11, an operating system program (hereinafter called OS) which is a control program of the CPU 1 is stored. In a font ROM 3a of the ROM 3 or the external memory 11, font data used for the document process is stored. In a data ROM 3c of the ROM 3 or the external memory 11, various data used when performing the document process is stored.

The RAM 2 functions as a main memory and a work area of the CPU 1. The KBC 5 is a keyboard controller and controls key input from the keyboard 9 and a pointing device (not drawn). The CRTC 6 is a CRT controller and controls display of the CRT 10. Further, the CRT 10 may be of course a liquid crystal monitor. The DKC 7 is a disk controller and controls access to the external memory 11 storing a boot program, various applications, font data, a user file, an edit file, and a printer control command preparation program (hereinafter, referred to as a printer driver). The external memory 11 is composed of, for example, a hard disk (HD).

The PRTC 8 is a printer controller, which is connected to a printer 200 via a predetermined two-way interface 21 and executes a communication control process with the printer 200.

Further, the CPU 1 executes, for example, an outline font development process (rasterizing) to a display information RAM preset on the RAM 2 and enables WYSIWYG on the CRT 10. Further, the CPU 1, on the basis of a command instructed by a mouse cursor on the CRT 10, opens various registered windows and executes various data processes. A user, when executing printing, opens the window concerning print setting and sets the printer and the print process for the printer driver including selection of the print mode.

The printer 200 is composed of, for example, a printer CPU 12, a ROM 13, a system bus 15, a printing part interface 16, a printing part (printer engine) 17, an input part 18, a RAM 19, and a memory controller (MC) 20.

The printer CPU 12, on the basis of a control program stored in a program ROM 13b of the ROM 13 or a control program stored in an external memory 14, realizes various control of the printer 200. For example, the CPU 12, to the printing part (printer engine) 17 connected to the system bus 15, outputs an image signal as output information via the printing part interface 16. In the program ROM 13b of the ROM 13, a control program of the CPU 12 is stored. In a font ROM 13a of the ROM 13, font data used to generate output information is stored. A data ROM 13c of the ROM 13, when it is a printer having no external memory 14 such as a hard disk, stores information used by the host computer.

The CPU 12 can communicate with the host computer 100 via the input part 18 and is structured so as to inform information in the printer 100 to the host computer 100. The RAM 19 functions as a main memory and a work area of the CPU 12.

The MC 20 controls access of the external memory 14 such as a hard disk (HD) or an IC card. The external memory 14 is optionally connected and can store font data, an emulation program, and form data. Further, an operation part 2 installed in the printer 200, switches for various operations, and an LED indicator are arranged.

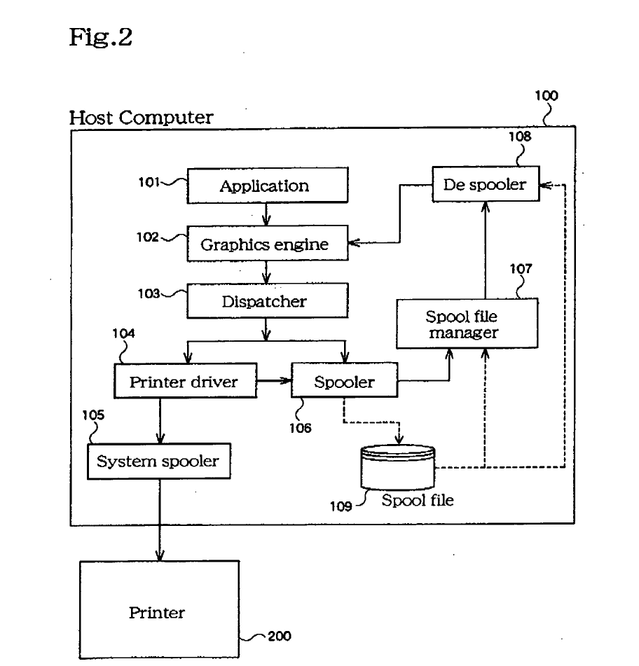

FIG. 2 is a block diagram showing the function constitution of the print process of the host computer 100. Needless to say, the function constitution indicated here, if the function of the present invention is executed, can be modified properly. An application 101, a graphics engine 102, a printer driver 104, and a system spooler 105 are program modules which exist as files preserved in the external memory 11 and when they are to be executed, are loaded in the RAM 2 by the OS and module using its module and are executed. The application 101 and the print driver 104, via, for example, a CD-ROM or a network (both not drawn) of the external memory 11, can be added to the hard disk of the external disk 11. The application 101 preserved in the external memory 11 is loaded in the RAM 2 and is executed, though when printing the print er 200 from the application 101, the graphics engine 102 which is loaded in the RAM 2 and can be executed outputs (draws). The graphics engine 102 loads the printer driver 104 provided for each printer from the external memory 11 into the RAM 2 and converts the output of the application 101 to a printer control command using the printer driver 104. The converted printer control command, via the system spooler 105 loaded in the RAM 2 by the OS and via the interface 21, is output to the printer 200.

To release the application 101 from the print process in a short time, when sending a print command from the graphics engine 102 to the printer driver 104, the printing control apparatus may be structured so as to generate once a spool file 109 composed of an intermediate code. At the point of time when a spooler 6 finishes to output all print commands from the graphics engine 102 to the spool file 109, the application is released. Further, in the system shown in FIG. 2, for the contents of the spool file 109, the processing of changing the page printing order and rotating and outputting print data can be performed.

Generally, to process print data, setting is performed from the window (user interface) provided by the printer driver 104 and the printer driver 104 stores the set contents in the RAM 2 or the external memory 11.

Hereinafter, the print data generation method will be explained by referring to FIG. 2. A dispatcher 103 receives a print command from the graphics engine 102. When the print command received by the dispatcher 103 from the graphics engine 102 is a print command issued from the application 101 to the graphics engine 102, the dispatcher 103 loads the spooler 106 stored in the external memory 11 into the RAM 2 and sends the print command to the spooler 106.

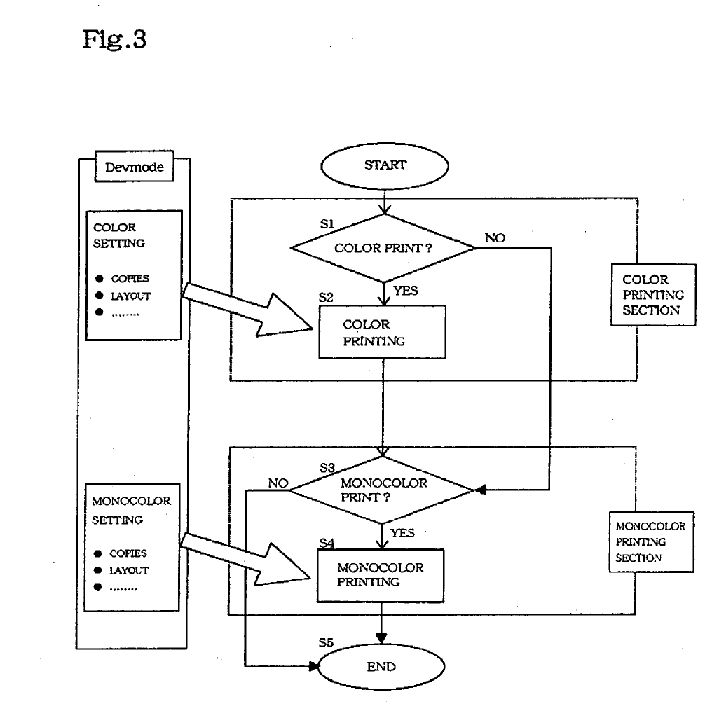

The spooler 106 converts the received print command to an intermediate code and outputs it to the spool file 109. Further, the spooler 106 obtains the processing setting concerning the print data set in the printer driver 104 from the printer driver 104 and preserves it in the spool file 109. Further, in FIG. 3, the spool file 109 is generated in the external memory 11 as a file. However, it may be generated in RAM 2.

The spooler 106 loads a spool file manager 107 stored in the external memory 11 in the RAM 2 and informs the generation state of the spool file 109 to the spool file manager 107

The spool file manager 107 judges whether printing can be performed according to the processing setting contents concerning the print data stored in the spool file 109 or not, that is, whether data enough to perform printing is spooled or not. For example, when the processing setting is 2 up, for the output of one physical page, print data of 2 pages is required, so that the spool file manager 107 judges whether data of 2 pages is spooled or not. When the spool file manager 107 judges that printing can be performed using the graphics engine 102, it loads a De spooler 108 stored in the external memory 11 in the RAM 2 and instructs the De spooler 108 to perform the intermediate code printing described in the spool file 109.

The De spooler 108 processes the intermediate code included in the spool file 109 according to the processing setting contents included in the spool file 109 and outputs it again via the graphics engine 102. When the print command received by the dispatcher 103 from the graphics engine 102 is a print command issued from the De spooler OB to the graphics engine 102, the dispatcher 103 sends the print command to the printer driver 104 instead of the spooler 106. The printer driver 104 generates a printer control command and outputs it to the printer 200 via the system spooler 105.

The processing of the printing control apparatus of this embodiment having the aforementioned constitution will be explained below. In this embodiment, by one print, instruction, a plurality of output states of monochromatic print and color print can be executed. Furthermore, designation of respective numbers of copies and layout setting of Nin1 print for contracting and printing data of several pages in one page can be performed.

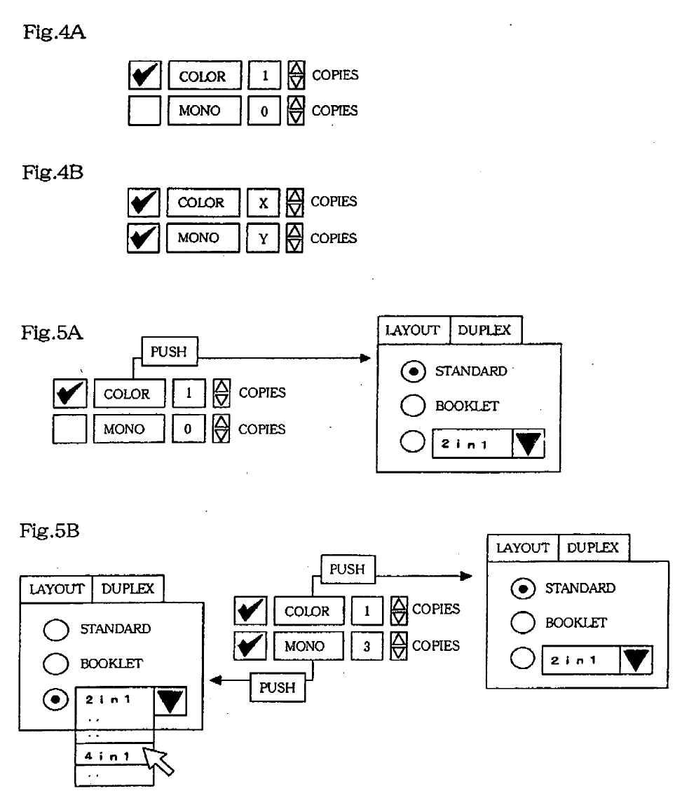

FIGS. 4A and 4B are drawings showing the setting method of the number of color and monochromatic print copies in this embodiment, and FIG. 4A shows default setting, and FIG. 4B shows user setting. The printer driver 104 in this embodiment displays a GDI as shown in FIGS. 4A and 4B on the CRT 10. In the GDI, a color check box, a monochromatic check box, and buttons for setting the number of copies are provided. In the default setting, the color check box is checked and the number of print copies is 1.

When a user performs monochromatic print in addition to color print, the monochromatic check box is checked and the number of print copies is set. In the setting example shown in FIG. 4B, color print is set to X copies and monochromatic print is set to Y copies.

In this embodiment, a GDI which can not only set the number of color and monochromatic print copies but also perform detailed print setting such as layout for each print job can be structured. In the GDI shown in FIG. 5A, when the color print check box is checked, the color button becomes active and the respective settings can be performed. Here, the number of color print copies is 1 and the standard layout setting example is shown. Furthermore, when the monochromatic print checkbox is checked, the monochromatic button becomes active and setting can be performed. In the GDI shown in FIG. 5B, Duplex is checked, so that it is double-side print setting, and 4in1 is checked, so that data of 4 pages is printed on one sheet, and a monochromatic print setting example of 3 copies is shown.

When execution of print is instructed after the aforementioned designation, the print command issued from the application 101 is transferred to the spooler 106 via the graphics engine 102 and the dispatcher 103. The spooler 106 converts the received print command to an intermediate code and outputs it to the spool file 109, simultaneously obtains the processing setting (here, the color print is standard layout and the number of copies is 1, and the monochromatic print is 4in1 and double-side print, and the number of copies is 3) concerning the print data set in the printer driver 104 from the printer driver 104, and preserves it in the spool file 109.

The spool file manager 107 loads the De spooler 108 stored in the external memory 11 into the RAM 2 and instructs the De spooler 108 to perform the intermediate code print process at the processing setting described in the spool file 109.

Further, the print setting operation via the user interface does not need to be executed for each print and when the setting operation is not to be performed, the print process to be continued without changing the default set value or the print setting which is set previously is executed. The print setting data set by a user is stored in a memory called a Devmode structure.

The process in this embodiment is started by operating the keyboard 9 shown in FIG. 1 by a user, thereby designating the printer of the print destination by the application 101 in execution and instructing print execution.

When the user presses the print button on the application, a print job start command is issued to the printer driver via the GDI (graphics device interface) and the driver prepares print data. At this time, the printer driver prepares print data by referring to the print setting in which the color setting and monochromatic setting including the number of print copies are stored respectively in different Devmode structures. When the process is finished, job end is called from the printer driver and the GDI opens the driver and transfers the prepared print data to the OS.

Hereinafter, the operation of the spool file manager 107 in this embodiment, that is, the process of the printer driver in the wide sense will be explained by referring to the flow chart shown in FIG. 3.

Firstly, at Step S1, the spool file manager 107, at the start time of print, judges whether color print is set or not. When color print is set, the manager goes to Step 2 and when color print is not set, the manager goes to Step S3.

At Step S2, the color print process is performed and color print data is generated by the driver. The print setting and number of copies setting preserved in the color setting area of the Devmode structure are used.

When the color print process is finished, the manager goes to Step S3.

At Step S2, the spool file manager 107 judges whether monochromatic print is set or not. When monochromatic print is set, the manager goes to Step 4 and when monochromatic print is not set, the manager goes to Step S5.

At Step S4, on the basis of the color print data and the print setting and number of copies setting preserved in the monochromatic setting area of the Devmode structure, the monochromatic print process is performed and monochromatic print data is generated.

When the color print data and monochromatic print data are generated, the driver process is finished (Step S5) In the embodiment of the present invention, both color print and monochromatic print can be set on the GDI and for both, the number of copies can be designated. When the number of color print copies or the number of monochromatic print copies is 1 or more, the color print setting button or the monochromatic print setting button can be used and print setting such as layout can be performed. The respective settings are preserved in the color area and monochromatic area of the Devmode structure and are used for printing.

Further, a print mode switching mechanism installed in the printer can be realized, for example, by using a switching mechanism of color print and monochromatic print disclosed in Japanese Patent Application 2001-88355.

As mentioned above in detail, according to the embodiment of the present invention, by one operation, for each of color print and monochromatic print, the number of copies designated by a user can be obtained.

When the operation of the printer driver finished by one job is performed for a plurality of jobs, print results of both color print and monochromatic print can be obtained, so that the convenience is improved.

It goes without saying that various obvious modifications and simple variants come within the scope of the present invention beyond the above-described embodiment.

What is claimed is:

1. A printing control apparatus, comprising:
(1) print setting means capable of setting simultaneously print modes of color print and monochromatic print for same data to be printed,
(2) generation means for generating a plurality of print jobs of said color print and said monochromatic print set by said print setting means from said data to be printed, and
(3) execution control means for executing printing by said plurality of print jobs generated by said generation means.

2. An apparatus as set forth in claim 1, wherein said print setting means is initialized to a predetermined print mode.

3. An apparatus as set forth in claim 1, wherein said print setting means can set a number of print copies for each print mode.

4. An apparatus as set forth in claim 1, wherein said print setting means can set double-side print DUPLEX.

5. An apparatus as set forth in claim 1, wherein said print setting means can set layout.

6. An apparatus as set forth in claim 5, wherein said layout by said print setting means is Nin1.

7. An apparatus as set forth in claim 1, wherein said print jobs have a print mode switching mechanism for switching said color print and said monochromatic print composed of intermediate data.

8. 1. A printing control apparatus, comprising:
(1) print setting means capable of setting simultaneously print modes of color print and monochromatic print for same data to be printed,
(2) generation means for generating a plurality of print jobs of said color print and said monochromatic print set by said print setting means from said data to be printed, wherein said generation means including:
holding means for holding said data to be printed and said set information set by said setting means as data in a predetermined form,
conversion means for converting said data to be printed to print data according to said set information held by said holding means, and
print job generation means for, by using said conversion means, generating print data corresponding to said set information by said setting means and generating said plurality of print jobs, and
(3) execution control means for executing printing by said plurality of print jobs generated by said generation means.

9. An apparatus as set forth in claim 1, wherein said execution control means transmits said print jobs generated by said generation means to a printer.

10. An apparatus as set forth in claim 8, wherein said execution control means transmits said print jobs generated by said generation means to a printer.

11. A method of controlling the printing, comprising:
(1) a print setting step capable of setting simultaneously print modes of color print and monochromatic print for same data to be printed,
(2) a generation step of generating a plurality of print jobs of said color print and said monochromatic print set by said print setting step from said data to be printed, and
(3) an execution control step of executing printing by said plurality of print jobs generated by said generation step.

12. A method as set forth in claim 11, wherein said print setting step is initialized to a predetermined print mode.

13. A method as set forth in claim 11, wherein said print setting step can set a number of print copies for each print mode.

14. A method as set forth in claim 11, wherein said print setting step can set double-side print DUPLEX.

15. A method as set forth in claim 11, wherein said print setting step can set layout.

16. A method as set forth in claim 15, wherein said layout by said print setting step is Nin1.

17. A method as set forth in claim 11, wherein said print jobs at said generation step have a print mode switching mechanism for switching said color print and said monochromatic print composed of intermediate data.

18. A method of controlling the printing, comprising:
(1) a print setting step capable of setting simultaneously print modes of color print and monochromatic print for same data to be printed,
(2) a generation step of generating a plurality of print jobs of said color print and said monochromatic print set at said print setting step from said data to be printed, wherein said generation step including:
a holding step of holding said data to be printed and said set information set at said setting step as data in a predetermined form,
a conversion step of converting said data to be printed to print data according to said set information held at said holding step, and
a print job generation step for, via said conversion step, generating print data corresponding to said set information at said setting step and generating said plurality of print jobs, and
(3) an execution control step of executing printing by said plurality of print jobs generated at said generation step.

19. A method as set forth in claim 11, wherein said execution control step transmits said print jobs generated at said generation step to a printer.
